(19) United States
(12) Patent Application Publication
(10) Pub. No.: US 2025/0043515 A1
(43) Pub. Date: Feb. 6, 2025

(54) ARRANGEMENT FOR INDUCTIVELY SUPPLYING ENERGY AND METHOD FOR MANUFACTURING THE SAME

(71) Applicants: Magment GmbH, Munich (DE); Heritage Environmental Technologies, LLC, Indianapolis, IN (US); Heritage Research Group, LLC, Indianapolis, IN (US)

(72) Inventors: Gerald Anton Huber, Indianapolis, IN (US); Xishun ZHANG, Indianapolis, IN (US); Christopher Paul Campbell, Indianapolis, IN (US); Mauricio Esguerra, Munich (DE); Rafael M. Acevedo Daunas, Bethesda, MD (US); Ibrahim Reda Ibrahim Ellithy Ibrahim, Munich (DE); Shaishav Koirala, Munich (DE)

(73) Assignees: Magment GmbH, Munich (DE); Heritage Environmental Technologies, LLC, Indianapolis, IN (US); Heritage Research Group, LLC, Indianapolis, IN (US)

(21) Appl. No.: 18/361,957

(22) Filed: Jul. 31, 2023

(51) Int. Cl. E01C 9/00; B60L 53/122; B60L 53/126; E01C 7/18; E01C 23/14

(52) U.S. Cl. CPC E01C 9/00; B60L 53/122; B60L 53/126; E01C 7/187; E01C 23/14

(57) ABSTRACT

Embodiments of the present disclosure relate to an arrangement for inductively supplying energy and a method for manufacturing the arrangement. The method includes: a transmitter coil being on-site embedded in or on top of a magnetizable asphalt mixture below a surface of a drivable civil structure and configured to provide a magnetic field to transfer energy to a receiver coil. The magnetizable asphalt mixture includes an asphalt binding substance and soft magnetic particles, and a volume fraction of the soft magnetic particles is not smaller than 35% of a total mixture volume of the magnetizable asphalt mixture.

### TECHNICAL FIELD

Embodiments of the present disclosure generally relate to wireless charging technologies, and more particularly, to an arrangement for inductively supplying energy, a method for manufacturing the arrangement, and a smart pavement system including the arrangement.

### BACKGROUND

There are many wireless charging technologies for providing power for vehicles. One of the wireless charging technologies is an electromagnetic induction charging technology, in which when current flows through a primary coil (also called as a transmitter coil) connected to a power source, a magnetic field is generated, and the magnetic field serves as a medium for energy transfer, by means of which a current is induced in a secondary coil (also called as a receiver coil) which may be arranged on underside of a vehicle. Accordingly, the vehicle can be charged.

In some related arts, in order to implement such electromagnetic induction charging, a device (a transmitter) is built, and is installed inside the pavement. In such technology, the installment of the transmitter inside the pavement is susceptible to cracking.

### SUMMARY

Embodiments of the present disclosure provide an arrangement for inductively supplying energy, a method for manufacturing the arrangement, and a smart pavement system including the arrangement.

According to an aspect, there is provided an arrangement for inductively supplying energy, including:
a transmitter coil being on-site embedded in or on top of a magnetizable asphalt mixture below a surface of a drivable civil structure and configured to provide a magnetic field to transfer energy to a receiver coil;
wherein the magnetizable asphalt mixture includes an asphalt binding substance and soft magnetic particles, and a volume fraction of the soft magnetic particles is not smaller than 35% of a total mixture volume of the magnetizable asphalt mixture.

According to another aspect, there is provided a smart pavement system, including:
an arrangement for inductively supplying energy, the arrangement including:
a transmitter coil being on-site embedded in or on top of a magnetizable asphalt mixture below a surface of a drivable civil structure and configured to provide a magnetic field to transfer energy to a receiver coil;
wherein the magnetizable asphalt mixture includes an asphalt binding substance and soft magnetic particles, and a volume fraction of the soft magnetic particles is not smaller than 35% of a total mixture volume of the magnetizable asphalt mixture;
wherein the smart pavement system further includes a top layer of the drivable civil structure, the top layer including inductive healing asphalt mixture;
wherein the transmitter coil is configured to provide heating energy to the top layer in response to presence of cracks.

According to another aspect, there is provided a method for manufacturing an arrangement for inductively supplying energy to a vehicle, including:
preparing a magnetizable asphalt mixture and a surrounding asphalt mixture;
compacting the magnetizable asphalt mixture and the surrounding asphalt mixture on a base of a drivable civil structure to make the surrounding asphalt mixture surround the magnetizable asphalt mixture;
providing, on a freshly-placed layer of the magnetizable asphalt mix mixture, a transmitter coil to make the transmitter coil embedded in or on top of the magnetizable asphalt mixture; and
providing a top layer covering the magnetizable asphalt mixture and the surrounding asphalt mixture and the transmitter coil;
wherein the transmitter coil is configured to provide a magnetic field to transfer energy to a receiver coil;
wherein the magnetizable asphalt mixture includes an asphalt binding substance and soft magnetic particles, and a volume fraction of the soft magnetic particles is not smaller than 35% of a total mixture volume of the magnetizable asphalt mixture.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 is a schematic diagram showing an arrangement for inductively supplying energy according to an embodiment of the present disclosure.

FIG. 2 shows a schematic cross section of the structure of a magnetizable asphalt mixture that can be used in the arrangement according to an embodiment of the present disclosure.

FIG. 3 shows a schematic cross section of a road where the magnetizable asphalt mixture is surrounded by regular asphalt mixture.

FIG. 4 schematically shows the electromagnetic emissions from a transmitter coil.

FIG. 5 schematically shows a relationship between the initial magnetic permeability of asphalt mixtures and ferrite volume fraction.

FIG. 6A shows a ground assembly (GA) coil and the magnetic field generated by the current flowing in the coil without magnetizable asphalt.

FIG. 6B schematically shows a GA coil embedded in a magnetizable asphalt core and the focused magnetic field generated by the current flowing in the coil embedded in magnetizable asphalt.

FIG. 7A schematically shows a smart pavement system according to an embodiment of the present disclosure.

FIG. 7B schematically shows another smart pavement system according to an embodiment of the present disclosure.

FIG. 8 is schematic flowchart of a method for manufacturing an arrangement for inductively supplying energy according to an embodiment of the present disclosure.

### DETAILED DESCRIPTION

Although specific configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Before introducing the technologies provided by embodiments of the present disclosure, some terminologies used herein are first described.

Asphalt binder—a black cementitious material, typically from the residue of crude oil refining that is used to glue aggregate particles together. In Europe this material is referred to as “bitumen”.

Asphalt mixture or asphalt mix—in the normal sense, this is a mixture of broken pieces of rock (aggregate particles) of different sizes that are combined to produce a mixture of aggregate particles coated with asphalt binder. During the construction process the aggregate particles are coated with asphalt binder and the mixture is compacted on the road to produce an asphalt layer as part of a pavement structure.

The following describes the embodiments of the present disclosure.

Embodiments of the present disclosure relate to a novel arrangement for inductive energy supply, e.g., to any type of electric vehicle and/or hybrid vehicle, such as trucks, cars, forklifts, service vehicles, etc., traveling or parked on an asphalt road, parking lot, or other asphalt surface, by integrating one or more transmitter coils into the pavement at sufficient depth to allow for routine maintenance road practices to be done on the road, without affecting the arrangement.

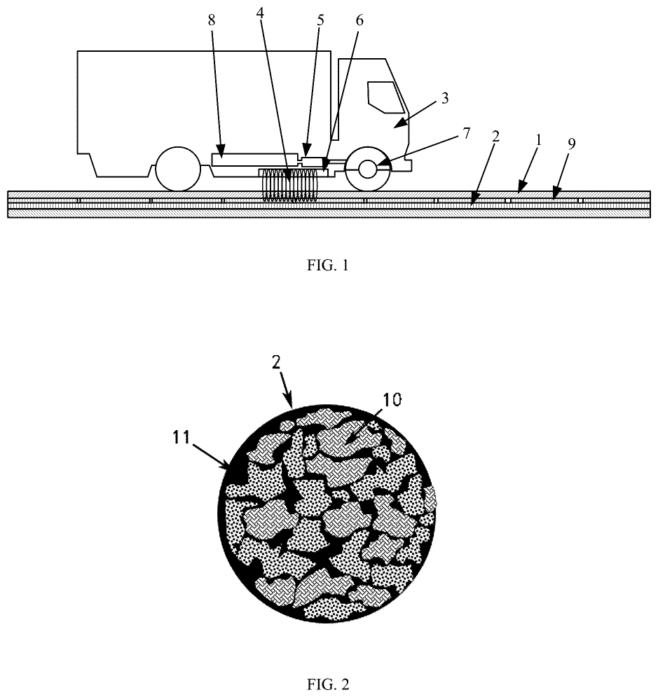

FIG. 1 is a schematic diagram showing an arrangement for inductively supplying energy according to an embodiment of the present disclosure. As shown in FIG. 1, one or more transmitter coils 9 are arranged (optionally, the transmitter coils 9 may be arranged in series) and embedded in or on top of a magnetizable asphalt mixture 2. The transmitter coils 9 are configured to generate a magnetic field 4. In this figure, the helix lines schematically represent magnetic field lines that are focused by means of the magnetizable asphalt mixture 2 towards a receiver or receiver coil 6 (antenna) attached on the underside of a vehicle 3. When the vehicle 3 with the receiver coil(s) 6 comes within the range of the magnetic field 4 provided, for example, if an alternating voltage is induced in the receiver coil(s) 6, the receiver coil(s) 6 converts the magnetic field into electricity which can be used to power the vehicle 3 or charge a vehicle battery 8. The induced AC voltage, for example, can also be rectified and used for storage in the vehicle battery 8.

According to the embodiment shown, the transmitted electrical energy can also be forwarded directly to a drive 7 with the aid of a suitable control module 5. The AC voltage required to supply the transmitter coils 9 with the current required for energy transmission is generated by inverters which are expediently connected to the transmitter coils 9 embedded in or on top of the magnetizable asphalt mixture 2.

In the charging system for an electric vehicle and/or hybrid vehicle described here, the transmitter coil 9, through which an electrical current flows, is connected to a power source (e.g., the inverters), generating a magnetic field. This magnetic field serves as a medium for the energy transfer, through which a current is induced in the receiver coil 6, either by relative movement between the transmitter and receiver coils or by fluctuation of the magnetic field when an alternating current flows through the transmitter coil 9. In such arrangement, the transmitter coil 9 is embedded under the travelled lane of a roadway, while the receiver coil 6, which receives the current, is attached to the underside of the vehicle.

For the novel arrangement provided in embodiments of the present disclosure, the transmitter coil is placed on-site as an integral part of the construction process of a drivable civil structure (e.g., road construction process). Thus, the transmitter coil and the magnetizable asphalt mixture and the surrounding asphalt mixture can form an integral structure with suitable engineering properties for the drivable civil structure (e.g., road), and thus good bonding performance can be achieved, thereby avoiding cracking of the drivable civil structure.

In an embodiment of the present disclosure, the drivable civil structure may be an asphalt road, or asphalt floor inside or outside a building. For example, If the vehicle is a forklift or other vehicle that operates primarily indoors, such as a warehouse, the transmitter coil may be embedded in the floor or attached to the surface of the floor of the building.

FIG. 2 shows a schematic cross section of the structure of the magnetizable asphalt mixture 2 that can be used in the arrangement according to an embodiment of the present disclosure. The magnetizable asphalt mixture 2 includes an asphalt binding substance 11 and soft magnetic particles 10. The soft magnetic particles 10 may be coated with the asphalt binding substance 11 that are incorporated into a matrix to form the magnetizable asphalt mixture 2. The soft magnetic particles 10 are separated from one another by the asphalt binding substance 11.

The soft magnetic particles 10 may include soft ferrite particles or other type of magnetic particles. The particles may include at least two different sizes.

The binding substance 11 may be at least one of asphalt binder, epoxy, silicon or alternate binders composed of natural or synthetic non-crystalline materials.

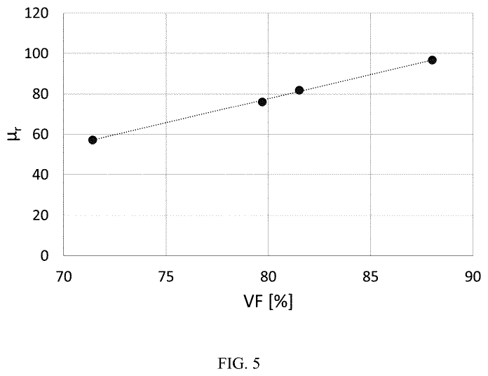

The magnetizable asphalt mixture is produced in a similar way as normal asphalt mixture except that soft ferrite materials are used instead of rock and particle size distributions are selected to obtain a high-volume fraction of not smaller than 35% and up to 90% of the total mixture volume of the magnetizable asphalt mixture 2. For example, the volume fraction may be 70% to 85%. As another example, the volume fraction may be 80%. FIG. 5 shows the initial magnetic permeability (ur) of the magnetizable asphalt as a function of ferrite volume fraction (VF). As can be seen from FIG. 5, a larger volume fraction results in a higher initial permeability. The higher the selected initial permeability, the more stray fields can be avoided and the lower the magnetic losses. The lower magnetic losses can make the slab slimmer and less expensive.

Aggregate particles in the magnetizable asphalt mixture 2 need to pack together sufficiently to occupy 35% and up to 90% (e.g., 70% to 85%) of the volume of the magnetizable asphalt mixture 2. This high percentage volume allows the magnetizable asphalt mixture to have the magnetic properties needed for high energy transfer.

The magnetizable asphalt mixture 2 becomes part of the drivable civil structure (e.g., pavement structure) and is specified in such a way as to comply with construction standards for highways, runways or other similar structures that will be subjected to loads for which the pavement structure is designed.

The arrangement therefore is a transmitter coil embedded in or on top of a magnetizable asphalt mixture which uses the asphalt binder to create the magnetizable asphalt mixture. Instead of asphalt binder, such a mixture can also be prepared with epoxy, silicon, or alternate binders composed of natural or synthetic non-crystalline materials. The main components of magnetizable asphalt mixture are one or more soft ferrite magnetic materials and a binder or binder mixture applied at ambient temperature or higher. Typically asphalt binder is mixed with aggregates at elevated temperature, about 150° C. Alternate technologies are available to allow mixing and compaction at lower temperature, even as low as ambient temperature (10 to 15° C.). In the finished magnetizable asphalt mixture, these components are mixed with one another as homogeneously as possible.

The transmitter coil is embedded in the magnetizable asphalt mixture containing binding substance (e.g., asphalt binder) which is compatible with the surrounding asphalt mixture (i.e., asphalt mixture surrounds the magnetizable asphalt mixture), enabling excellent bonding with its surrounding medium and becoming an integral part of the pavement structure.

FIG. 3 shows a schematic cross section of a road where the magnetizable asphalt mixture is surrounded by regular asphalt mixture. The magnetizable asphalt mixture 2 is integrated into the pavement/floor structure. The magnetizable asphalt mixture 2 is arranged below the road surface 1. The transmitter coil 9 is embedded on the top of the magnetizable asphalt mixture 2. Lift lines 12 indicates the asphalt layers that are used to construct the road. The asphalt layers are laid over a base 13 of the road structure.

As can be seen from FIG. 3, the magnetizable asphalt mixture 2 is surrounded by regular asphalt mixture. The aggregate particles of the magnetizable asphalt mixture 2 are different from aggregate particles of the surrounding asphalt mixture. The magnetizable asphalt mixture 2 uses soft ferrite materials as aggregate particles instead of rock, and the high-volume fraction of the soft ferrite particles enables the magnetizable asphalt mixture 2 to have magnetic properties needed for high energy transfer. And, the asphalt binder in the magnetizable asphalt mixture 2 is compatible with the surrounding asphalt mixture.

In an embodiment of the present disclosure, the arrangement allows on-site construction of a transmitter system that can be any shape and size, embedded in an asphalt or asphalt mixture road/floor, that can be any shape and size in a simple way, that can be reliably integrated into the road while at the same time obtaining optimal field focusing.

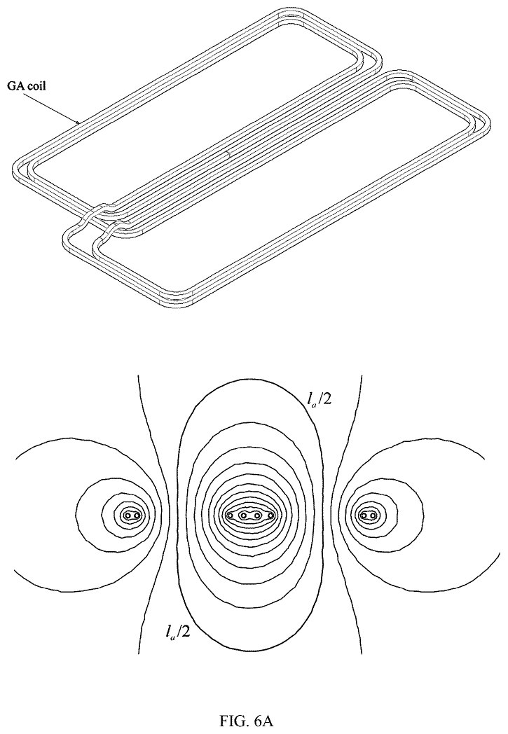

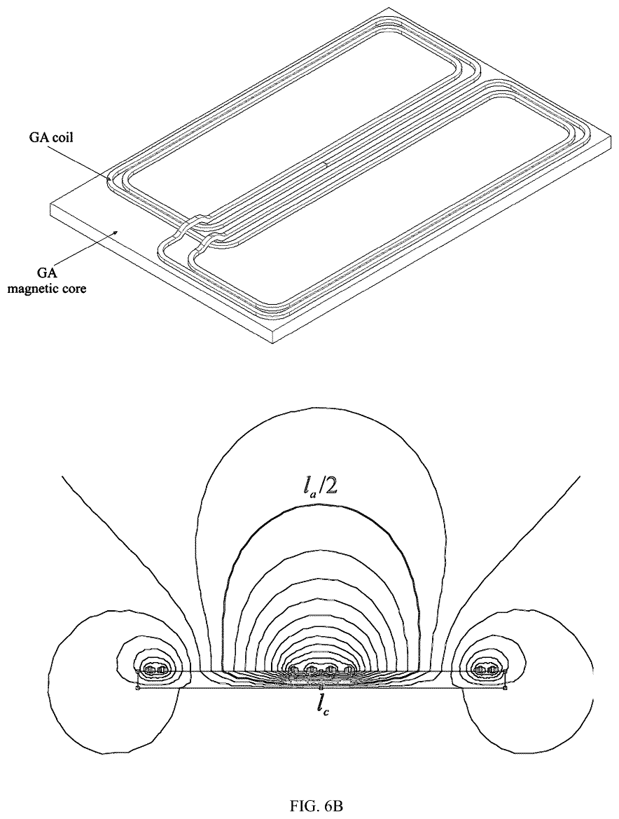

The magnetizable asphalt mixture, the transmitter coil geometry and its placement below the surface are designed in such a way as to maximize power transfer efficiency while reducing losses and stray fields that may impact on communications or health devices. The use of the magnetizable material with embedded transmitter coils focuses the magnetic field onto the receiver coil in such a manner that stray electromagnetic emissions are contained. FIG. 6A shows a ground assembly (GA) coil and the magnetic field generated by the current flowing in the coil without magnetizable asphalt, and FIG. 6B schematically shows a GA coil embedded in a magnetizable asphalt core and the focused magnetic field generated by the current flowing in the coil embedded in magnetizable asphalt.

Examples, which are not intended to be limiting, of coils or coil systems used in the arrangement are coils having a round, oval, elliptical, or polygonal cross-section, such as square, tetragonal, triangular, or hexagonal. The coils are usually used to provide an alternating magnetic field, with frequencies in the range from 10 kHz to 500 kHz, in particular 20 kHz to 100 kHz, being used as a rule. The necessary AC voltages and currents are supplied in a manner known per-se by inverters, which are connected to the transmitter coils via feed lines that should be advantageously as short as possible.

The magnetizable asphalt mixture may have a magnetic permeability greater than 70, preferably 80, for a particular embodiment the magnetic permeability may be 82 and the saturation of the magnetizable asphalt mixture may be about 0.38 T. The core losses may be less than 100 kW/m³, preferably <75 kW/m³, and more preferably <60 kW/m³, measured at a frequency of 50 kHz, and a flux density of 50 mT.

Magnetic permeability is a measure of the ease of magnetizing the ferrite particles in the presence of an electrical current. Saturation is maximum strength of the magnetic flux that can be generated. Magnetic flux is measured in units of Teslas (T). Losses are described as electrical energy passing through the coil that is converted into heat rather than into the magnetic field. This energy is measured in kW per cubic meter of magnetizable asphalt (the cubic meter refers to the volume of the magnetizable core). The loss is measured at specific frequency of 50 kHz and a magnetic flux of 50 mT.

The magnetizable mixture and coil arrangement may shape the magnetic field to ensure safety and protection by compliance with International Commission for Non-Ionizing Radiation Protection (ICNIRP), Federal Communications Commission (FCC) and Comité International Spécial des Perturbations Radioélectriques (CISPR) standards that minimize stray emissions.

The ICNIRP is an international commission specialized in non-ionizing radiation protection. The organization's activities include determining exposure limits for electromagnetic fields used by devices such as cellular phones.

The FCC sets standards for stray radiation emissions for devices that generate radiation such as will be the case for the transmitter in the pavement. These emission limits are focused on controlling stay emissions that may interfere with other electronic devices.

CISPR is an international committee founded in 1934 that sets standards for electromagnetic interference. Their scope includes high voltage equipment, electric/electronic equipment in vehicles, limits for protection of radio frequencies and electromagnetic compatibility.

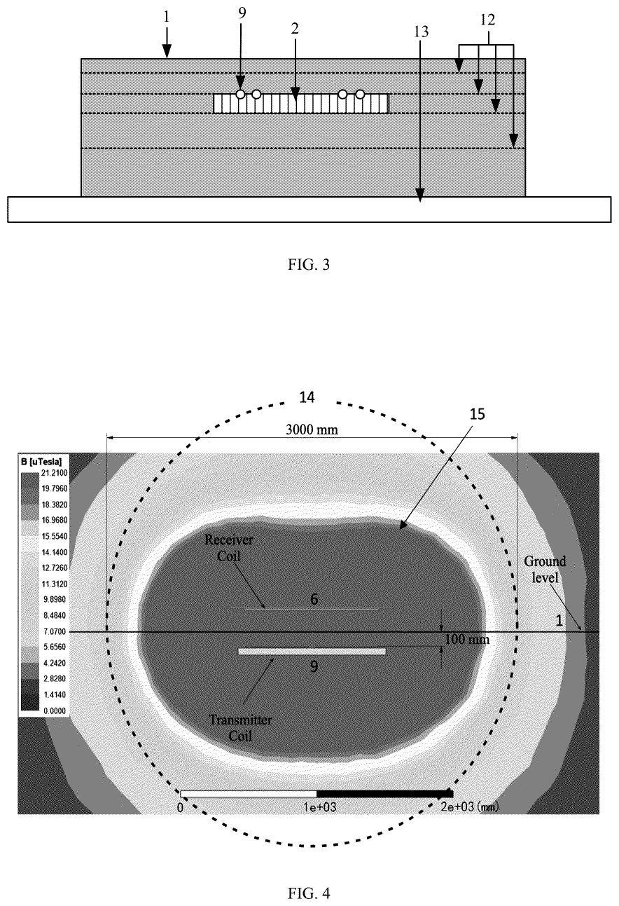

FIG. 4 shows the electromagnetic emissions from a transmitter coil, which occur in an X-Y-Z space. In the model of the magnetic field strength surrounding a paired transmitter and receiver coil shown in FIG. 4, the transmitter coil 9 is shown 100 mm below the surface of the road, ground level 1 and the receiver coil 6 is 150 mm above the surface. The dashed circular line 14 indicates the distance of 1500 mm from the center of the transmitter coil, the distance at which the electromagnetic emissions are evaluated for health and safety. The contour 15 shows the position beyond which the emissions is below the threshold limit of 21.21 uTpeak. The emission limits are specified by ICNIRP, the FCC and CISPR. In this figure the X (horizontal axis) is the lateral direction across the width of the road with the center of the transmitter coincident with the center of the lane width. The Z axis (vertical) is the vertical direction showing height above or below the road surface. The Y axis, looking into the figure, represents the direction of travel along the road. The influence of a metal vehicle (car, truck, etc.) on the magnetic field shape is not shown.

In an embodiment of the present disclosure, the transmitter coil may be a pre-shaped transmitter coil made of hollow conductive material and is embedded on-site on a freshly-placed layer of the magnetizable asphalt mixture in such a way as to improve transmission efficiency and the directing of the magnetic field towards the receiver coil on the vehicles.

The transmitter coil may be made of copper tubes or other electric conductive metal such as aluminum. For example, as shown in FIG. 6B, a transmitter coil 9 is made of hollow tubes of copper or other suitable high conductive metal. To minimize aging and degradation of electrical insulation, the protective coating for the tubes—may have high dielectric strength both at high frequencies and when subjected to large temperature variations. For this, the transmitter coil is sheathed by a protective coating material to realize the type of insulation, and the material may be selected from the class of Ethylene Propylene Diene Monomer (EPDM) and silicone rubber materials that also provide protection from degradation when contact with the asphalt binder mixture. For example, the hollow coil tube needs to be sheathed in a protective covering, that can be either heat shrink sleeving, protective immersion bath, enameling process, insulating tape or dip and bake varnishing process. Insulation needs to comply with electrical safety hipot testing. Hipot, shorthand for high potential, is an industry term for measuring the electrical insulation capability of a material to resist current flow under high voltage (high potential).

In some other embodiments, the coils can also be manufactured using Litz wire or similar conductive wire instead of hollow tubes.

Technical standards are being developed for wireless charging at power levels ranging in the kW to the MW range by the Society of Automobile Engineers (SAE) and the International Electrotechnical Commission (IEC). In an embodiment of the present disclosure, the magnetizable asphalt and the transmitter coil are designed to achieve maximum efficiency with the capability of transferring from 1 kW up to 2 MW of power from the electrical source to the vehicle with a minimum efficiency of 85%, to meet related technical standards.

The process of installing the magnetizable asphalt mixture and coils can also be done on existing roads (i.e., a retrofit) by creating a channel at the center of the lane to allow for the magnetizable mixture and the coil to be embedded in a similar way.

In some embodiments, the transmitter coil embedded in or on top of the magnetizable asphalt mixture may also be used in self-healing of cracks which occur in the drivable civil structure.

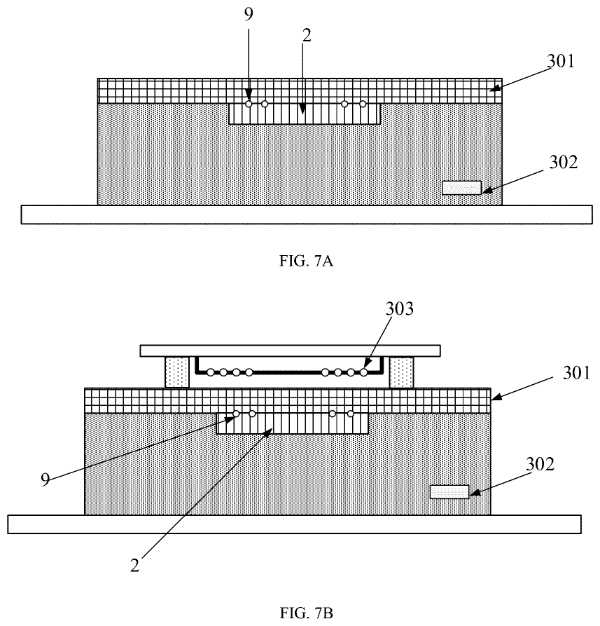

FIG. 7A schematically shows a smart pavement system according to an embodiment of the present disclosure.

The smart pavement system includes sensors 302 which detect cracks. The sensors 302 may be considered as constituting a self-assessment system.

The smart pavement system uses the same transmitter assembly containing the magnetizable asphalt mixture 2 and the transmitter coil 9 that is used to supply power to vehicles as shown in FIG. 1. This power can be used to heat a top layer 301 of the drivable civil structure. The top layer 301 may include an inductive healing asphalt mixture that contains magnetizable metallic particles that, when subject to a magnetic field, generate heat in response to a signal from the sensors 302 that detect the cracks.

FIG. 7B schematically shows another smart pavement system according to an embodiment of the present disclosure.

As shown in FIG. 7B, an alternate triggering mechanism for the transmitter coil 9 to operate may be an open circuit secondary coil 303 placed on a vehicle (the vehicle is used for self-healing process) that moves slowly over the top layer 301 of inductive healing asphalt mixture and initiates the self healing process. For example, the open circuit secondary coil 303 may trigger the transmitter coil 9 to generate a magnetic field for supplying heating energy to the inductive healing aspaht mixture, so as to make the self-healing.

The smart pavement system can be used for inductive self-healing of cracks in conductive asphalt concrete pavements to extend the service life of roads.

In an embodiment of the present, sensors 302 may be included in the self-assessment system to collect data, such as strain or damage states, and the collected data may be transmitted to a controller to determine whether there is crack. The controller may be implemented by CPU (central processing unit), micro-controller, micro-processor, ASIC (Application Specific Integrated Circuit) or other proper circuits, and optionally programs may be run on the controller to make determination of whether there is crack.

For a smart pavement system able to sense its internal condition and external environment, with a self-assessment system to detect the presence of cracks or microcracks that will trigger a healing-on-demand automated process by powering the current through the embedded transmitter coil until the inductive self-healing process has been successfully completed. This allows cracks or microcracks to be healed and provides sustainable road maintenance with highly reduced costs, pollution, and traffic disruptions.

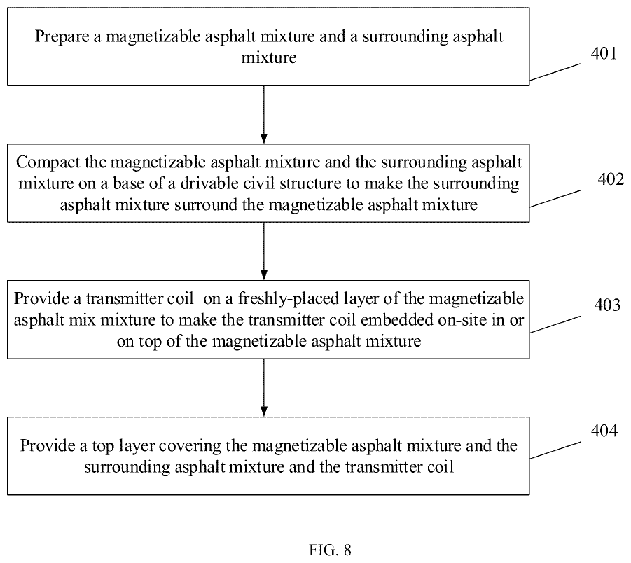

FIG. 8 is schematic flowchart of a method for manufacturing an arrangement for inductively supplying energy according to an embodiment of the present disclosure.

In step 401, a magnetizable asphalt mixture and a surrounding asphalt mixture are prepared.

In step 402, the magnetizable asphalt mixture and the surrounding asphalt mixture are compacted on a base of a drivable civil structure to make the surrounding asphalt mixture surround the magnetizable asphalt mixture.

In step 403, a transmitter coil is provided on a freshly-placed layer of the magnetizable asphalt mix mixture to make the transmitter coil embedded on-site in or on top of the magnetizable asphalt mixture.

In step 404, a top layer covering the magnetizable asphalt mixture and the surrounding asphalt mixture and the transmitter coil is provided.

The transmitter coil is configured to provide a magnetic field to transfer energy to a receiver coil. For example, the receive coil may be arranged on the vehicle.

The magnetizable asphalt mixture includes an asphalt binding substance and soft magnetic particles, and a volume fraction of the soft magnetic particles is not smaller than 35% of a total mixture volume of the magnetizable asphalt mixture.

According to an embodiment, the top layer may include a regular asphalt mixture (for a conventional road).

According to some other embodiments, the top layer may include an inductive healing asphalt mixture. Such top layer may be used for a self-healing road.

According to an embodiment, providing the top layer may include: providing the top layer including the inductive healing asphalt mixture which includes magnetizable metallic particles that, when subject to a magnetic field, generate heat in response to a signal from sensors. In this embodiment, the transmitter coil may be further configured to transfer energy to the top layer.

According to an embodiment, the volume fraction of the soft ferrite particles in the magnetizable asphalt mixture ranges from 35% to 90%.

According to an embodiment, the volume fraction of the soft ferrite particles is 70% to 85%.

According to an embodiment, the soft magnetic particles include soft ferrite particles of at least two different sizes; the binding substance includes at least one of an asphalt binder, epoxy, silicon or a binder including natural or synthetic non-crystalline materials.

According to an embodiment, the transmitter coil is a pre-shaped coil made using a rigid hollow conductive material, and the coil is sheathed by a protective coating material which is selected from class of Ethylene Propylene Diene Monomer (EPDM) and a silicone rubber material.

According to an embodiment, the transmitter coil is a conductive wire, such as Litz wire.

According to an embodiment, the magnetizable asphalt mixture and the transmitter coil are selected to achieve maximum efficiency with a capability of transferring up to 2 MW of power from an electrical source to the vehicle with a minimum efficiency of 85%.

According to an embodiment, aggregate particles of the magnetizable asphalt mixture are different from aggregate particles of the surrounding asphalt mixture and different from the inductive healing asphalt mixture of the top layer.

According to an embodiment, the binding substance in the magnetizable asphalt mixture is compatible with the surrounding asphalt mixture.

According to an embodiment, the magnetizable asphalt mixture is shaped to ensure field focusing of the magnetic field. In the manufacturing method of the arrangement, the transmitter coil is embedded or placed on top of a freshly-placed layer of the magnetizable asphalt mixture in an on-site construction, the shape and size of the asphalt mixture can be flexibly designed to adapted to actual road condition, while the transmitter coil and the asphalt mixture can be reliably integrated into the road.

The foregoing descriptions are merely exemplary embodiments of the present disclosure, but the protection scope of the present disclosure is not limited thereto. Any person skilled in the art can easily think of changes or substitutions within the technical scope of the present disclosure, and all the changes or substitutions should be covered by the protection scope of the present disclosure. Therefore, the protection scope of the present disclosure should be defied by the appended claims.

What is claimed is:

1. An arrangement for inductively supplying energy, comprising:
a transmitter coil being on-site embedded in or on top of a magnetizable asphalt mixture below a surface of a drivable civil structure and configured to provide a magnetic field to transfer energy to a receiver coil;
wherein the magnetizable asphalt mixture comprises an asphalt binding substance and soft magnetic particles, and a volume fraction of the soft magnetic particles is not smaller than 35% of a total mixture volume of the magnetizable asphalt mixture.

2. The arrangement according to claim 1, wherein the volume fraction of the soft ferrite particles in the magnetizable asphalt mixture ranges from 35% to 90%.

3. The arrangement according to claim 2, wherein the volume fraction of the soft ferrite particles is 70% to 85%.

4. The arrangement according to claim 1, wherein:
the soft magnetic particles comprise soft ferrite particles of at least two different sizes;
the binding substance comprises at least one of an asphalt binder, epoxy, silicon or a binder comprising natural or synthetic non-crystalline materials.

5. The arrangement according to claim 1, wherein the transmitter coil is a pre-shaped coil made using a rigid hollow conductive material, and the transmitter coil is sheathed by a protective coating material which is selected from class of Ethylene Propylene Diene Monomer (EPDM) and a silicone rubber material.

6. The arrangement according to claim 1, wherein the transmitter coil is a conductive wire.

7. The arrangement according to claim 6, wherein the conductive wire is Litz wire.

8. The arrangement according to claim 1, wherein aggregate particles of the magnetizable asphalt mixture are different from aggregate particles of a surrounding asphalt mixture.

9. The arrangement according to claim 8, wherein the binding substance in the magnetizable asphalt mixture is compatible with the surrounding asphalt mixture.

10. The arrangement according to claim 1, wherein the magnetizable asphalt mixture is shaped to ensure field focusing of the magnetic field.

11. A smart pavement system, comprising:
an arrangement for inductively supplying energy, the arrangement comprising:
a transmitter coil being on-site embedded in or on top of a magnetizable asphalt mixture below a surface of a drivable civil structure and configured to provide a magnetic field to transfer energy to a receiver coil;
wherein the magnetizable asphalt mixture comprises an asphalt binding substance and soft magnetic particles, and a volume fraction of the soft magnetic particles is not smaller than 35% of a total mixture volume of the magnetizable asphalt mixture;
wherein the smart pavement system further comprises a top layer of the drivable civil structure, the top layer comprising an inductive healing asphalt mixture;
wherein the transmitter coil is configured to provide heating energy to the top layer in response to presence of cracks.

12. The smart pavement system according to claim 11, wherein the smart pavement system further comprises sensors configured to detect presence of cracks;
wherein the inductive healing asphalt mixture comprises magnetizable metallic particles that, when subject to a magnetic field, generate heat in response to a signal from the sensors.

13. The smart pavement system according to claim 11, further comprising:
an open circuit secondary coil placed on a vehicle used for a self-healing process and configured to trigger the transmitter coil to generate a magnetic field for providing heating energy to the inductive healing asphalt mixture.

14. A method for manufacturing an arrangement for inductively supplying energy, comprising:
preparing a magnetizable asphalt mixture and a surrounding asphalt mixture;
compacting the magnetizable asphalt mixture and the surrounding asphalt mixture on a base of a drivable civil structure to make the surrounding asphalt mixture surround the magnetizable asphalt mixture;
providing, on a freshly-placed layer of the magnetizable asphalt mix mixture, a transmitter coil to make the transmitter coil embedded in or on top of the magnetizable asphalt mixture; and
providing a top layer covering the magnetizable asphalt mixture and the surrounding asphalt mixture and the transmitter coil;
wherein the transmitter coil is configured to provide a magnetic field to transfer energy to a receiver coil;
wherein the magnetizable asphalt mixture comprises an asphalt binding substance and soft magnetic particles, and a volume fraction of the soft magnetic particles is not smaller than 35% of a total mixture volume of the magnetizable asphalt mixture.

15. The method according to claim 14, wherein the top layer comprises an inductive healing asphalt mixture;
wherein providing the top layer comprises:
providing the top layer comprising the inductive healing asphalt mixture which comprises magnetizable metallic particles that, when subject to a magnetic field, generate heat in response to a signal from sensors which detect presence of cracks;
wherein the transmitter coil is further configured to transfer energy to the top layer.

16. The method according to claim 14, wherein the volume fraction of the soft ferrite particles in the magnetizable asphalt mixture ranges from 35% to 90%.

17. The method according to claim 14, wherein:
the soft magnetic particles comprise soft ferrite particles of at least two different sizes;
the binding substance comprises at least one of an asphalt binder, epoxy, silicon or a binder comprising natural or synthetic non-crystalline materials.

18. The method according to claim 14, wherein the transmitter coil is a pre-shaped coil made using a rigid hollow conductive material, and the coil is sheathed by a protective coating material which is selected from class of Ethylene Propylene Diene Monomer (EPDM) and a silicone rubber material.

19. The method according to claim 14, wherein the transmitter coil is a conductive wire.

20. The method according to 15, wherein aggregate particles of the magnetizable asphalt mixture are different from aggregate particles of the surrounding asphalt mixture and different from the inductive healing asphalt mixture of the top layer.
